(19) United States
(12) Patent Application Publication
(10) Pub. No.: US 2022/0287497 A1
(43) Pub. Date: Sep. 15, 2022

(54) APPARATUS, SYSTEM, AND METHOD FOR ADJUSTABLE CUP SHELF

(71) Applicant: RJ Brands, LLC d/b/a Chefman, Mahwah, NJ (US)

(72) Inventors: Arie O. Holtz, Jerusalem (IL); Mehrafza Mirzazad, Brooklyn, NY (US)

(73) Assignee: RJ BRANDS, LLC d/b/a Chefman, Mahwah, NJ (US)

(21) Appl. No.: 17/372,490

(22) Filed: Jul. 11, 2021

Related U.S. Application Data
(60) Provisional application No. 63/158,886, filed on Mar. 10, 2021.

(51) Int. Cl. A47J 31/44

(52) U.S. Cl. CPC A47J 31/4482; A47J 31/4425

(57) ABSTRACT

Provided is an apparatus for use with a coffee maker, the apparatus. The apparatus may include a cup shelf and a track disposed vertically, the track comprising a rail, the rail having a top rail portion and a bottom rail portion. The apparatus may include a switch having a hinge pin and a hook pin, where the switch is configured to be pressed by a user, where the cup shelf is vertically movable, and where the hook pin is configured to interface with the top rail portion.

### CLAIM OF PRIORITY

This application claims priority from U.S. Provisional Patent Application No. 63/158,886, filed on Mar. 10, 2021, the contents of which are incorporated herein by reference.

### TECHNICAL FIELD OF THE INVENTION

The invention is related generally to the field of household appliances. More particularly, the invention relates to apparatuses, methods, and systems for an adjustable cup-shelf coffee maker.

### INTRODUCTION

There are a number of coffee maker devices on the market. Many coffee makers incorporate a spout that projects coffee into the user's coffee mug. However, a problem remains that when attempting to fill a coffee mug, there is a substantial distance between the spout and rim of the mug, which may cause coffee to splatter. Overspray or splatter from the spout may stain or damage one's kitchen or clothing. Additionally, over time, overspray or splatter of coffee may create recognizable economic loss. Moreover, some coffee makers offer a specially formed mug that may attempt to reduce splatter, but this requires use of a specific mug in a specific way, and does not allow the user to utilize their preferred drinking cup.

One may try to manually move their mug closer to the spout, however it can be dangerous to hold one's bare skin proximate to the flowing hot coffee. In some coffee makers there is a “stand” (that is a separate part), which may be placed under the cup to raise it up toward the spout. In some other coffee makers, a shelf may swing out. For example, the shelf can be on a hinge and be integrated into the wall when not needed and pulled out (on the hinge) when required. The problem with the first option is that the separate nonintegrated part can easily get misplaced or lost. Further, the problem with the second option is that the swing-out shelf requires a lot of space that is not available in a compact coffee machine. Moreover, both options are also costly and promote clutter.

The present coffee maker and system overcomes the foregoing problems and others, and enables users to adjust the height of their coffee mug on the coffee maker to minimize overspray and splatter.

### SUMMARY

The present system relates to a coffee maker apparatus comprising, a cup shelf; a track disposed vertically, the track comprising a rail, the rail having a top rail portion and a bottom rail portion; and a switch disposed on the cup shelf, the switch having a hinge pin and a hook pin, wherein the switch is configured to be pressed by a user, wherein the cup shelf is vertically movable, wherein the hook pin is configured to latch on to the top rail portion.

The invention of the present disclosure may be an apparatus for use with a coffee maker, the apparatus may comprise a cup shelf and a track disposed vertically, the track comprising a rail, the rail having a top rail portion and a bottom rail portion. The apparatus may also include a switch having a hinge pin and a hook pin, where the switch is configured to be pressed by a user, where the cup shelf is vertically movable, and where the hook pin is configured to interface with the top rail portion. In an embodiment, the cup shelf may be configured to move between a top position and a bottom position. The apparatus may also include a shelf back wall orthogonal to the cup shelf. In a further embodiment, the cup shelf includes a depression sized to accept a cup. In an embodiment, the apparatus further includes a cup shelf rim and one or more tabs, where the one or more tabs are disposed on the cup shelf rim.

In an embodiment, the apparatus further comprises one or more springs perpendicular to the shelf back wall, where the one or more springs exert an outward force on a bottom portion of the switch such that the hook pin exerts an inward force. In an embodiment, the hook pin and the top rail portion may connect at the top position. Further, the switch may include a switch protrusion. In an embodiment, the apparatus may include a switch opening disposed on the shelf back wall, where the switch opening is sized to accept the switch.

In an embodiment, the apparatus further comprises a door configured to move in a vertical direction, a door hook configured to interface with the switch, and a door spring configured to exert a vertical force on the door. In such an embodiment, the door may traverse the switch opening in the bottom position.

In an embodiment, the switch protrusion in a natural state is extended outward from the shelf back wall in the bottom position and the bottom portion of the switch in the natural state is extended outward from the shelf back wall in the top position. Further, in the natural state in the bottom position the switch protrusion and the shelf back wall may form an acute angle and in the natural state in the top position the bottom portion of the switch and the shelf back wall may form an acute angle. In an embodiment, in an actuated state in the bottom position the switch protrusion may be depressed and/or in the actuated state in the top position the bottom portion of the switch may be depressed.

Additional embodiments and operations of the cooking device and system are discussed in further detail in connection with the figures.

### BRIEF DESCRIPTION OF DRAWINGS

FIG. 1 is a perspective view of one example of an embodiment of a coffee maker with a cup shelf in the bottom position.

FIG. 2 is a perspective view of one example of an embodiment of a coffee maker with a cup shelf in the top position.

FIG. 3 is a perspective view of the track construction of a coffee maker.

FIG. 4 is a side sectional view of an embodiment of the invention where the cup shelf is in the bottom position.

FIG. 5 is a sectional view of the switch in the bottom position.

FIG. 6 is a side sectional view of an embodiment of the invention where the cup shelf is in the top position.

FIG. 7 is a sectional view of the switch in the top position.

FIG. 8 is an embodiment of a switch including a door in the bottom position.

FIG. 9 is an embodiment of a switch including a door in the top position.

### DETAILED DESCRIPTION OF EMBODIMENTS

Throughout the specification, wherever practicable, like structures will be identified by like reference numbers. In some figures, components, such as additional electrical connections or fasteners have been omitted for clarity in the drawings. Unless expressly stated otherwise, the term “or” means “either or both” such that “A or B” includes A alone, B alone, and both A and B together. For the purposes of this disclosure, it is understood that the invention's functional use with “coffee machines” may extend to other beverage machines and dispensers. Further, terms such as “cup,” “glass,” and “mug,” unless stated otherwise, should be understood as functionally identical.

Although the present device and system has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

The invention of the present disclosure may be used to raise a cup higher and/or closer to the spout of a beverage dispenser (for example, a coffee machine) to prevent splash. For example, the cup may sit on a cup shelf. The cup shelf may sit in a track, having a top position and bottom position. In some embodiments, the cup shelf may be removable. In other embodiments, the cup shelf may be permanently affixed to the coffee machine.

The cup shelf may be associated with a switch. The switch may be designed such that operation of the switch is intuitive to the user. When the shelf is in the bottom position, the switch may protrude in a manner that allows for the user to insert a finger and raise the shelf. When the shelf arrives at the top position an indicator may be used. The indicator may be an audible click and the switch may change positions, such that the bottom of the switch protrudes and the top of switch sinks into the wall. A user may push on the protruding part of the switch, causing the shelf to return to the bottom position. In an embodiment, the switch release can only be activated when the cup shelf is in the top position (for example, the user may feel resistance when attempting to operate the switch release in the bottom position).

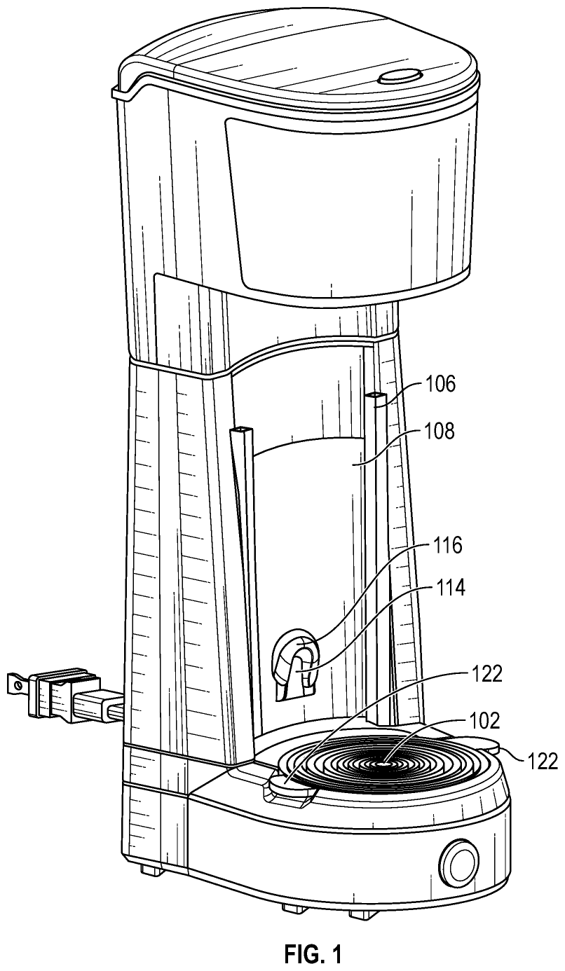

Referring to FIG. 1, the coffee maker may include a cup shelf 102, one or more grooves 106, a shelf back wall 108, a switch 114, a switch protrusion 116, and one or more tabs 122. The cup shelf 102 may be sized and configured to accept a coffee mug, tumbler, cup, or other beverage container. The cup shelf 102 may be constructed as a circular disc. Alternatively, the cup shelf 102 may be oval, square, or any other shape. In an embodiment, the cup shelf 102 includes a cup shelf rim that surrounds the perimeter of the shelf 102. In one embodiment, the cup shelf 102 may have a textured pattern on its surface. In another embodiment, the cup shelf 102 may be semi-hollow, having a cavity and vents along the top surface of the cup shelf 102. In such an embodiment, the bottom surface of the cup shelf 102 may be closed, such that coffee or other fluids may enter the vents and be captured within the semi-hollow cavity of the cup shelf 102. In another embodiment, the cup shelf 102 may include vents enabling fluids to be captured in a reservoir (for example, an overflow reservoir) disposed on or in the base of the coffee machine. In another embodiment, the cup shelf 102 may feature a depression or sink (for example, configured to hug the bottom portion of a mug). The sidewalls of the depression may be tapered from the mouth of the depression to the base of the depression (for example, to interface with a standard disposable sloped-wall coffee cup).

In an embodiment, the cup shelf 102 has two positions: a top position and a bottom position. In another embodiment, the cup shelf 102 has more than two positions. The cup shelf 102 may include a customizable number of positions. In an alternate embodiment, the cup shelf 102 may move vertically and horizontally (for example, the cup shelf may be able to move away and towards the shelf back wall 108). In such an alternate embodiment, the cup shelf 102 may rest on one or more horizontal tracks. In one embodiment, the cup shelf 102 lowers into a well or base of the coffee maker. In such an embodiment, the well or base of the coffee maker may have indentations along the well or base rim sized to accept the one or more tabs 122 (for example, such that the top surface of the one or more tabs 122 is flush with the top surface of the base of the coffee maker). The cup shelf 102 and/or the one or more tabs 122 may be indented so that a rubber pad may be disposed over the cup shelf 102 and/or the one or more tabs 122. In such an embodiment, a layer of adhesive may be disposed between the rubber pad and the cup shelf 102.

The coffee maker may include one or more grooves 106 that may envelope the edges of the shelf back wall 108. As a non-limiting example, the left side and right side of the shelf back wall 108 may be flared, such that the shelf back wall edges are captured by the grooves 106. The grooves 106 may be integral to the coffee maker or may be attached to the coffee maker. The grooves 106 may have inward facing cut-outs sized to accept the edges of the shelf back wall 108. In another embodiment, the edges of the shelf back wall 108 rest between the grooves 106 and track 104, such that the edges of the shelf back wall 108 are held in place (for example, allowing a wide enough tolerance to enable the shelf back wall 108 to move vertically).

The shelf back wall 108 may include a switch 114 and a switch protrusion 116. In such an embodiment, the switch 114 may sit in the shelf back wall 108. In one embodiment, a user may lift the cup shelf 102 from the one or more tabs 122 or from the switch protrusion 116. However, in an alternate embodiment, the user may adjust the cup shelf 102 from any number or combination of locations.

The one or more tabs 122 may be disposed on the sides of the cup shelf 102. Alternatively, the one or more tabs 122 may be integral to the cup shelf 102. The one or more tabs 122 may be textured (for example, to provide a better grip to the user). The one or more tabs 122 may be semi-circles protruding horizontally from the cup shelf 102. In some embodiments, the one or more tabs 122 may be square or any other shape. In an embodiment, the one or more tabs 122, the cup shelf 102, the base of the coffee maker, or any other part of the invention of the present disclosure, may include magnets. As a non-limiting example, the one or more tabs 122 and the base of the coffee maker may be fitted with magnets, such that the cup shelf 102 tightly occupies the base of the coffee maker. In an embodiment, the coffee maker includes a hydraulic, pneumatic, piston, or spring mechanism that prevents the cup shelf 102 from descending too quickly. For example, the shelf back wall 108 and/or cup shelf 102 may be in communication with such a retarding mechanism, such that the vertical movement of the cup shelf 102 is slowed by the retarding mechanism.

In an embodiment, the cup shelf 102, the shelf back wall 108, and the one or more tabs 122 are integral (for example, all three of the aforementioned components are made from one continuous piece of material). In an embodiment, the shelf back wall 108 includes a switch opening sized to accept the switch 114. The switch 114 may be disposed within the switch opening, between the shelf back wall 108 and the channel 110. The switch opening or shelf back wall 108 may include one or more attachment points, allowing the switch 114 to attach to the shelf back wall 108. The switch opening may include one or more holes configured to accept one or more sides of the hinge pin 120, holding the switch 114 in place. The bottom portion of the switch opening may include one or more indentations or connection points configured to accept the one or more springs 128. In one embodiment, the bottom of the switch 114 interfaces with two springs in parallel to each other, the two springs perpendicular to the shelf back wall 128. The one or more springs 128 may be captured by one or more spring capture tabs around the rim of the switch opening. Thus, the one or more springs 128 may exert a force on the bottom of the switch 114, causing the top of the switch 114 to push into the top of the rail 126 when the cup shelf 102 is in the top position.

The shelf back wall 108 may be sized to fit within the track 104. For example, the shelf back wall 108 may be sized to fit between the spout and the base of the coffee maker. The shelf back wall 108 may further have a height sufficient to enable the switch 114 to reach the top of the rail 126. The height of the cup shelf 102 in the top position may be configured to allow a standard size coffee mug to fit between the cup shelf 102 and the spout.

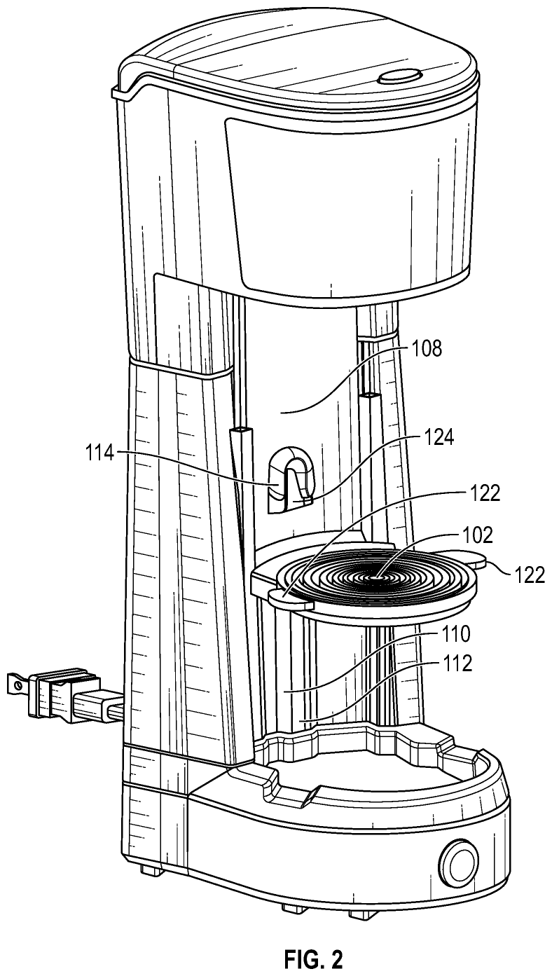

Referring to FIG. 2, the coffee maker may also include a channel 110, a rail 112, and a bottom of switch 124. In an embodiment, the channel 110 may be disposed vertically along the coffee maker or the shelf back wall 108. The rail 112 may be disposed vertically along the middle of the channel 110. In an embodiment, the bottom of the switch 124 may be pushed to lower the cup shelf 102 to the bottom position. The rail 112 may be a thin vertical member. In an embodiment, the rail 112 is a rectangular prism. However, in alternate embodiments, the rail 112 may be any geometric shape. In an embodiment, the inside surface of the switch 114 includes a groove sized to accept the rail 112 (for example, the switch 114 may, in part, surround the rail 112). In an embodiment, the switch 114 does not surround the rail 112, instead the rear face of the shelf back wall 108 includes a protrusion that surrounds the rail 112. In such an embodiment, the rear protrusion of the shelf back wall 108 may partially or completely house the switch 114 and/or related components, such as the spring(s) 128.

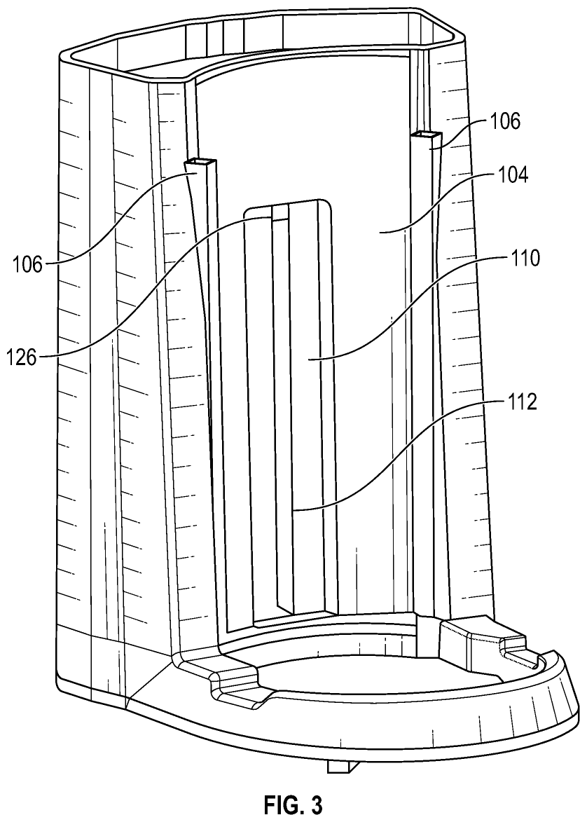

Referring to FIG. 3, the coffee maker may also include a track 104. The cup shelf 102 may sit in a track 104, and may be non-removable. In some embodiments, the cup shelf 102 is removable from the track 104. The track 104 may be formed to stabilize the cup shelf 102. In an embodiment, the rail 112 may influence the position of the switch 114. In an alternate embodiment, the track 104 may also influence the position of the switch 114. In an embodiment, the track 104 may contain the one or more grooves 106 that envelop the edges on the side of shelf back wall 108, the channel 110, and/or the rail 112.

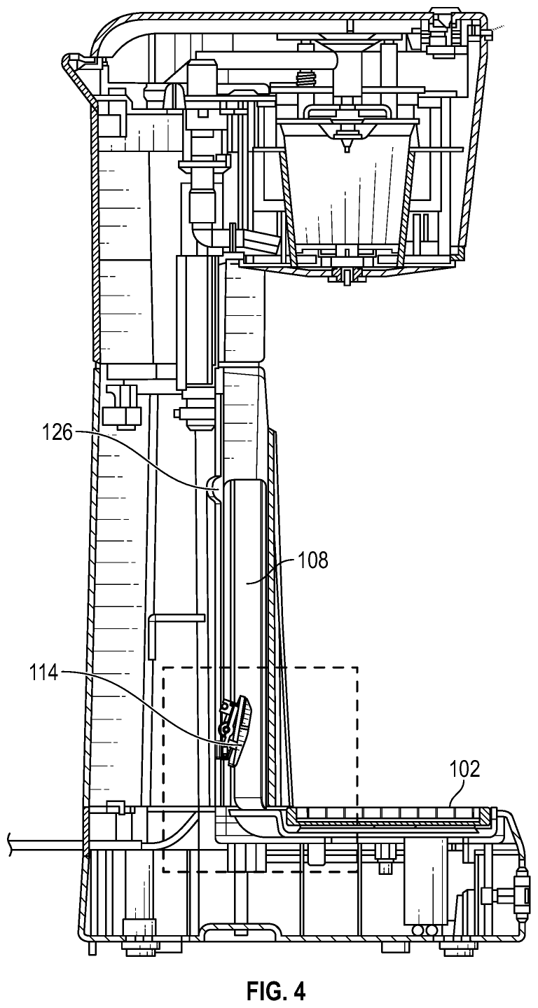

Referring to FIG. 4, the coffee maker may also include a top of rail 126. The top of rail 126 may be disposed on the top portion of the rail 112. The top of the rail 126 may also be integral to the rail 112. The top of the rail 126 may function as a “stop” for the cup shelf 102 and/or an interfacing mechanism for the switch 114.

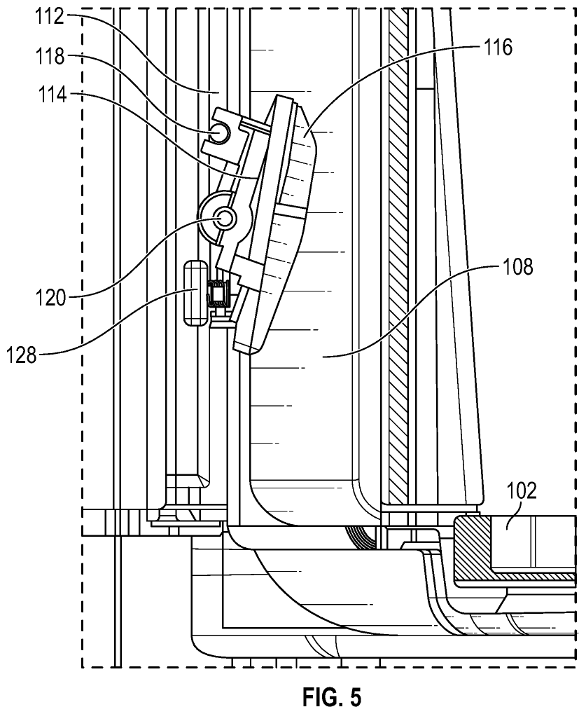

Referring to FIG. 5, the coffee maker may also include a hook pin 118, a hinge pin 120, and one or more springs 128. The switch 114 may sit in the shelf back wall 108 and may be held in place by a hinge pin 120. The hinge pin 120 may act as a pivot, allowing the switch 114 to move on the hinge pin 120 axis. The switch 114 may have a hook pin 118 that is constantly pressed against the rail 112 by the one or more springs 128. In an embodiment, the top of rail 126 may be congruent with the hook pin 118. For example, the top of rail 126 may include a round peg and the hook pin 120 may include a round peg chamber, such that when the two interface, the top of rail 126 and hook pin 118 are temporarily locked together. In some embodiments, the hook pin 120 may be a flat surface that rests upon the top of rail 126, such that the downward weight on the cup shelf 102 maintains the cup shelf 102 in the top position.

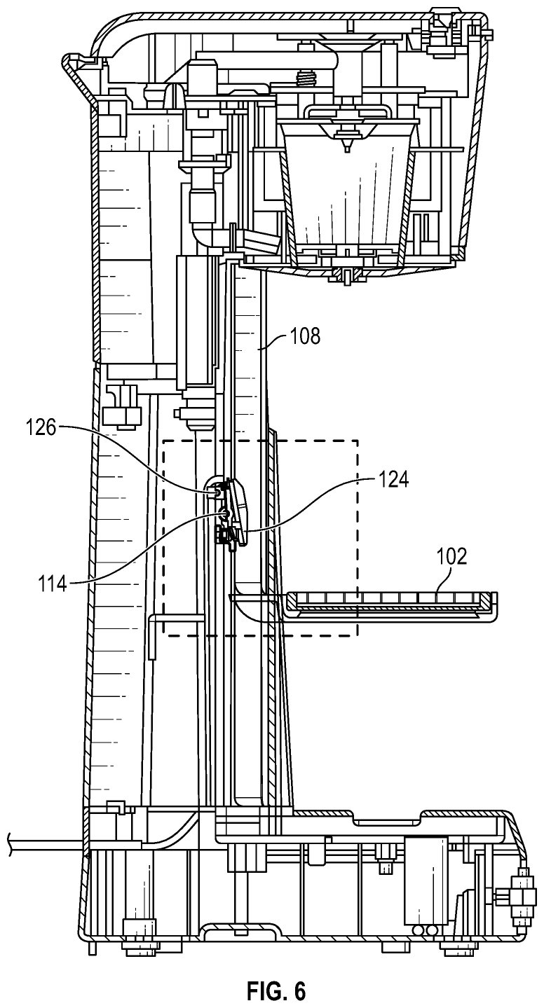

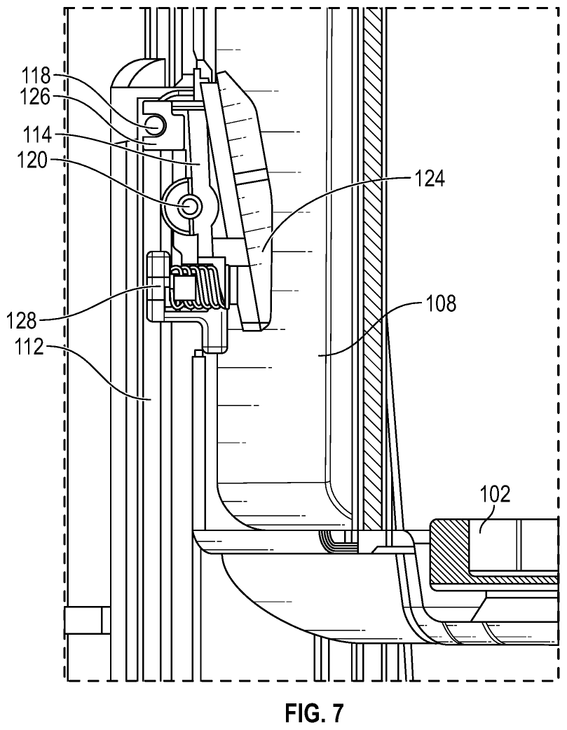

Referring to FIGS. 6-7, when the cup shelf 102 arrives at the top position, the switch 114 flips, and the hook pin 118 locks on to the top of the rail 126. The hook pin 118 may be formed from steel, or any other suitable material. In an embodiment, every component of the invention of the present disclosure is composed of plastic, except the pins 118-120 and spring 128. In another embodiment, the pins 118-120 and/or spring 128 are also composed of plastic. In a further embodiment, the hook pin 118 is round, having minimal friction and surface contact with the rail 112. In such an embodiment, the contact between the hook pin 118 and the rail 112 allows for smooth motion of the cup shelf 102. In some embodiments, the mechanism of the hook pin 118, hinge pin 120, and the one or more springs 128 is embedded in the channel 110 (for example, to minimize visibility to a user).

In an embodiment, the switch body may include one or more holes. In one embodiment, one of the holes may be occupied by the hinge pin 120. In some embodiments, the hinge pin 120 may intersect the switch body at or near the center of mass of the switch 114, minimizing the amount of torque needed to move the switch 114 about the hinge pin 120. The bottom of the switch 114 may be configured to rest on the bottom lip of the channel 110 when the cup shelf 102 is in the bottom position. In an alternate embodiment, the hinge pin 120 may be located at any position on the switch 114.

In one embodiment, the switch 114 and/or the switch protrusion 116 include a thumb-hold. For example, the switch 114 may include one or more protrusions on its surface, allowing a user to gain more leverage when lifting the switch 114. In some embodiments, the top of the switch 114 may include a lip. In certain embodiments, the switch protrusion 116 includes a lip.

In various embodiments, the shelf back wall 108 includes one or more thumb-holds. For example, the shelf back wall 108 may include one or more indentations or lips disposed such that the user may lift the shelf back wall 108 from the indentations or lips. The surface of switch 114 or switch protrusion 116 may be textured, or covered with a textured pattern or material, such as a cleat pattern or any other suitable textured material.

In an embodiment, the switch 114 is configured to be in the position required for the user's convenience. In such an embodiment, when the cup shelf 102 is in the bottom position, the switch 114 may provide a means via the switch protrusion 116 for lifting the cup shelf 102 (for example, the switch protrusion 116 may be textured, include a lip or rim, or otherwise enable a user to grip the switch 114). In an embodiment, the cup shelf 102 may also be lifted by a user via the tabs 122. In an embodiment, the switch protrusion 116 is a hood, rim, or lip disposed on the top portion of the switch 114. Further, when the cup shelf 102 is in the top position, the bottom of the switch 124 may protrude from the shelf back wall 108, enabling the user to press the bottom of the switch 124, allowing the cup shelf 102 to return to the bottom position. Thus, in an embodiment, the switch 114 is positioned such that it may be actuated by the user to bring the cup shelf 102 to the opposite position. However, in another embodiment, the switch protrusion 116 and/or bottom of the switch 124 may be angled towards the user while also not protruding past the shelf back wall 108. In such an embodiment, the switch 114 may be recessed in the shelf back wall 108, such that a user may insert a finger into the switch opening in the shelf back wall 108 to actuate the switch 114. In an embodiment, if the user incompletely presses the switch 114 (for example, as not to fully disengage the hook pin 118 from the top of rail 126), the switch 114 may return to its natural state upon the user's release (for example, as a function of the one or more springs 128).

In an embodiment, in the bottom position, the switch protrusion 116 may extend outward from the opening in the shelf back wall 108. As a non-limiting example, the switch 114 and/or switch protrusion 116 may rotate about the hinge pin 120 and form an acute angle between the vertical axis of the shelf back wall 108 and the switch 114. In such an example, when the cup shelf 102 is in the bottom position, the top of the switch 114 and/or switch protrusion 116 may form a 10-60 degree angle with the shelf back wall 108. However, in another embodiment, in the bottom position, the switch 114 and/or switch protrusion 116 may form any angle less than 10 degrees or greater than 60 degrees. In an embodiment, in the bottom position, the switch protrusion 116 and/or switch 114 does not move about hinge pin 120 axis. For example, the rail 112 (or other component) may obstruct the switch 116 and/or switch 114 from moving. Thus, the user may move the cup shelf 102 without actuating the switch protrusion 116 while the cup shelf 102 is in the bottom position. While in the bottom position, the cup shelf 102 (as a function of the non-moving switch 114) may be in immediate condition for vertical movement.

In an embodiment, in the bottom position, as the user presses or actuates the top of the switch 114, the angle between the top of the switch 114 and the shelf back wall 108 may decrease to about 0 degrees. However, the top of the switch 114 may be placed into any angle sufficient to enable movement of the cup shelf 102 (for example, any angle that enables the switch 114 to clear any of the obstructing components of the device, such as the opening of the shelf back wall 108, the rail 112, the channel 110, or other such components). In another embodiment, when actuating the switch 114 in the bottom position, the top of the switch 114 and/or switch protrusion 116 may depress in the device beyond the vertical axis of the shelf back wall 108.

In an embodiment, the user may move the cup shelf 102 from the bottom position to the top position without pressing the switch 114. In such an embodiment, merely lifting the cup shelf 102 via the switch protrusion 116, tabs 122, or other component, enables the cup shelf 102 to move vertically. Further, in another embodiment, the angle of the switch protrusion 116 and/or bottom of switch 124 may be measured relative to a vertical axis or vertical plane, which intersects the hinge pin 120. Thus, angles disclosed in this disclosure may be interpreted relative to the vertical axis intersecting the hinge pin 120 or the vertical axis of the shelf back wall 108. In one embodiment, the vertical axis intersecting the hinge pin 120 may be geometrically synonymous to the vertical axis of the shelf back wall 108. However, in another embodiment, these two axes may differ.

In an embodiment, when the cup shelf 102 is in the top position, the bottom of the switch 124 may extend outward from the shelf back wall 108. Thus, in the top position, the top of the switch 114 and/or the switch protrusion 116 may extend inward. In such an embodiment, the switch 114 is positioned such that the bottom of the switch 124 is configured to be actuated or pressed by the user, lowering the cup shelf 102 to the bottom position. In an embodiment, in the top position, the bottom of the switch 124 may form a 10 to 60 degree angle with the vertical axis of the shelf back wall 108. However, in another embodiment, in the top position, the bottom of the switch 124 may form any angle less than 10 degrees or any angle greater than 60 degrees with the vertical axis of the shelf back wall 108. In an embodiment, the user may actuate or press the switch 114, such that the bottom of the switch 124 forms about a 0 degree angle with the vertical axis of the shelf back wall 108. However, when actuating the switch 114 in the top position, the bottom of the switch 124 may depress in the device beyond the vertical axis of the shelf back wall 108. In an embodiment, the bottom of the switch 124 may depress any amount required to sufficiently disconnect the hook pin 118 and the top of rail 126, thus enabling movement of the cup shelf 102 to the bottom position. For example, reducing the angle between the bottom of the switch 124 and the vertical axis to 5 degrees may be sufficient to separate the top of rail 126 from the hook pin 118, thus enabling movement of the cup shelf 102.

In an embodiment, the switch protrusion 116 and the bottom of the switch 124 may extend outward from the device due to force felt by the one or more springs 128. For example, in the bottom position, the switch protrusion 116 may sit at a 60 degree angle with the vertical axis of the shelf back wall 108 and movement of the cup shelf 102 may be enabled without depressing the switch protrusion 116. In an embodiment, the switch protrusion 116 may not be depressed by the user when the cup shelf 102 is in the bottom position. As a non-limiting example, the switch protrusion 116 may not be depressed because the rail 112 obstructs the hook pin 118. Thus, the switch protrusion 116 may remain at a 60 degree angle as the cup shelf 102 travels to the top position. However, in an alternate embodiment, the switch protrusion 116 may be depressed in the bottom position and/or when the cup shelf 102 is traveling between the bottom position and top position. In such an embodiment, the switch protrusion may be depressed to an angle of 0 degrees or any angle sufficient to enable motion of the cup shelf 102. In a non-limiting example, if the user only moves the switch protrusion 116 30 degrees, then the switch protrusion 116 will reset to its bottom position state once the user's finger is removed from the switch 114. Further, as the cup shelf 102 is returning to the bottom position from the top position, the switch protrusion 116 may automatically return to its bottom position state once the cup shelf 102 reaches the bottom position (for example, due to the force of the spring 128). However, in another embodiment, the switch protrusion 116 may automatically return to its bottom position natural state upon actuation by the user in the top position. However, in such an embodiment, the user may lower the cup shelf 102 some distance before the switch protrusion remains in its bottom position natural state for the remainder of travel to the bottom position. As a non-limiting example, the user may actuate the switch 114 in the top position and lower the cup shelf 102 by 5 mm, placing the hook pin 118 in its obstructed position relative to the rail 112, thus enabling the switch 114 to remain in its bottom position natural state during travel from the top position to bottom position.

In an embodiment, the switch 114 has a natural state (for example, the position of the switch 114 before user intervention) and an actuated stated (for example, the position of the switch 114 once pressed by the user). In such an embodiment, the natural state of the switch 114 in the bottom position may be indiscernible from the actuated state of the switch 114 in the bottom position (for example, an embodiment where the switch protrusion 116 does not depress in the bottom position). In an embodiment, the switch 114 in the bottom position may solely include a natural state.

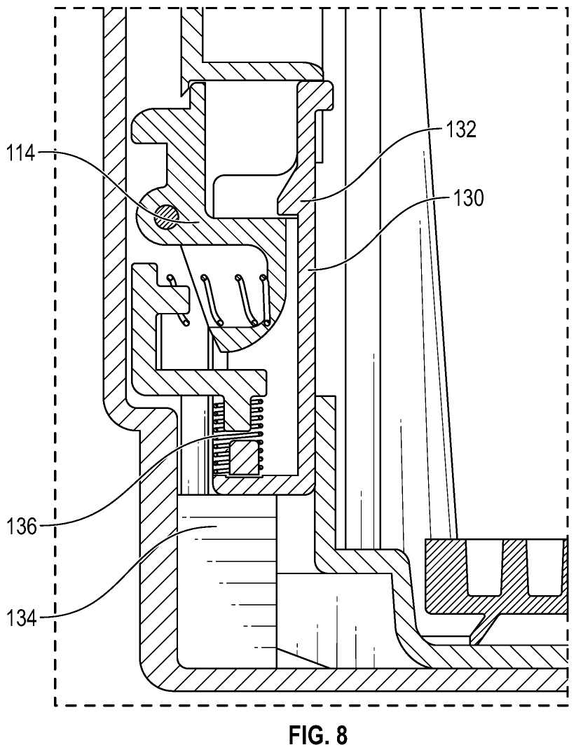

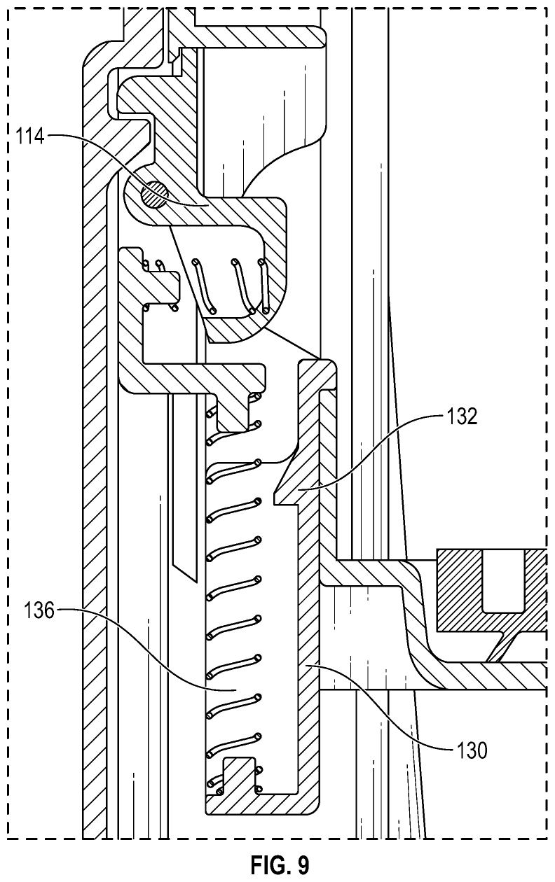

Referring to FIGS. 8-9, in an embodiment, a door 130 is disposed within the switch opening (or otherwise on the switch 114 or shelf back wall 108). The door 130 may be configured to move vertically within the switch opening, at any given time, leaving a portion of the switch opening open and a portion blocked off. However, the door 130 may also completely block the switch 114. In another embodiment, the door 130 may move horizontally within the switch opening. In one embodiment, the switch opening may contain a set of tracks, enabling movement of the door.

When the cup shelf 102 is in the top position, the switch 114 tilts, releasing the door 130, and enabling the door 130 to fall. In such embodiments, a user may press on the switch 114, enabling the cup shelf 102 to go to the bottom position, allowing the door 130 to move up and latch onto the switch 114. In a further embodiment, the door 130 may prevent access to the switch 114 when the cup shelf 102 is in the bottom position. In another embodiment, one or more ribs 134 are disposed within the channel 110, such that the one or more ribs 134 push the door 130 up when the cup shelf 102 reaches the bottom position. In an embodiment, the switch protrusion 116 is still visible and accessible to the user when the door 130 is closed.

In an embodiment, the door 130 includes a door hook 132. The door hook 132 may be a protruding portion of the door 130, facing towards the switch 114. The door hook 132 may interface with a corresponding portion of the switch 114 (for example, a flat portion on the switch 114). A door spring 136 may be disposed between the one or more ribs 134 and the switch 114 or door hook 132. In an embodiment, the door spring 136 compresses when the cup shelf 102 is in the bottom position and extends when the cup shelf 102 is in the top position. However, in an alternate embodiment, the door spring 136 may compress when the cup shelf 102 is in the top position and extend when the cup shelf 102 is in the bottom position.

In certain embodiments, the door 130 may be shaped akin to the letter “L.” Thus, the top portion of the door 130 may include a door hook 132 (a protrusion facing towards the switch 114) and a bottom portion (for example, a perpendicular base, where the perpendicular base includes an upward-facing peg configured to retain a door spring 136). When the cup shelf 102 is in the bottom position, the spring may compress, pushing the door 130 up, such that the door hook 132 catches on a portion of the switch 114. When the cup shelf 102 is in the top position, the door spring 136 may expand, moving the door 130 and door hook 132 away from the switch 114.

While this invention has been described in conjunction with the embodiments outlined above, many alternatives, modifications and variations will be apparent to those skilled in the art upon reading the foregoing disclosure. Accordingly, the embodiments of the invention, as set forth above, are intended to be illustrative, not limiting. Various changes may be made without departing from the spirit and scope of the invention.

What is claimed is:

1. An apparatus for use with a coffee maker, the apparatus comprising:
a cup shelf;
a track disposed vertically, the track comprising a rail, the rail having a top rail portion and a bottom rail portion; and
a switch having a hinge pin and a hook pin,
wherein the switch is configured to be pressed by a user,
wherein the cup shelf is vertically movable, and
wherein the hook pin is configured to interface with the top rail portion.

2. The apparatus of claim 1 wherein the cup shelf is configured to move between a top position and a bottom position.

3. The apparatus of claim 2 further comprising a shelf back wall orthogonal to the cup shelf.

4. The apparatus of claim 1 wherein the cup shelf comprises a depression sized to accept a cup.

5. The apparatus of claim 1 further comprising:
a cup shelf rim; and
one or more tabs,
wherein the one or more tabs are disposed on the cup shelf rim.

6. The apparatus of claim 3 further comprising one or more springs perpendicular to the shelf back wall, wherein the one or more springs exert an outward force on a bottom portion of the switch such that the hook pin exerts an inward force.

7. The apparatus of claim 6 wherein the hook pin and the top rail portion connect at the top position.

8. The apparatus of claim 1 wherein the switch includes a switch protrusion disposed on the switch.

9. The apparatus of claim 7 further comprising a switch opening disposed on the shelf back wall, the switch opening sized to accept the switch.

10. The apparatus of claim 9 further comprising:
a door configured to move in a vertical direction;
a door hook configured to interface with the switch; and
a door spring configured to exert a vertical force on the door.

11. The apparatus of claim 10 wherein the door traverses the switch opening in the bottom position.

12. The apparatus of claim 9 wherein the switch protrusion in a natural state is extended outward from the shelf back wall in the bottom position and the bottom portion of the switch in the natural state is extended outward from the shelf back wall in the top position.

13. The apparatus of claim 12 wherein in the natural state in the bottom position, the switch protrusion and the shelf back wall form an acute angle and in the natural state in the top position, the bottom portion of the switch and the shelf back wall form an acute angle.

14. The apparatus of claim 13 wherein in an actuated state in the top position the bottom portion of the switch is depressed.
